(19) United States
(12) Patent Application Publication
(10) Pub. No.: US 2011/0004888 A1
(43) Pub. Date: Jan. 6, 2011

(54) Screen sharing method with selective access to both data and logic of a shared application using a helper application

(76) Inventors: Sudharshan Srinivasan, Fremont, CA (US); Jai Kumar, Cupertino, CA (US); Kothandraman Ramchandran, Fremont, CA (US)

Correspondence Address: SUDHARSHAN SRINIVASAN, 5496 GOLUBIN COMMON, FREMONT, CA, 94555, US

(21) Appl. No.: 12/459,714

(22) Filed: Jul. 6, 2009

(51) Int. Cl. G06F 9/54

(52) U.S. Cl. 719/329

(57) ABSTRACT

A screen sharing system that enables selective access to application data and application logic is described. This screen sharing system is implemented by coupling a helper application (36) to an application that provides content referred to as content application (35).

The helper application is an application that has the ability to programmatically access the content application (35) using window system graphical user interface application programming interface. Helper application (36) is used to get and set content application data and interact with the content application using window system input events that simulate user input.

This method enables selective access to both application data and application logic that is necessary for use in a screen sharing system used by participants that may be trusted or may not be fully trusted.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to screen sharing methods and specifically to screen sharing methods that link a helper application with a shared application.

2. Prior Art

There are several screen sharing methods in prior art that enable collaborative access to application screens that are shared among participants of a collaborative communication session. Such applications may be executed on a desktop computer of one participant or may be executed on a server to provide access to multiple participants.

Screen sharing methods are used in communication sessions for collaborative work in which multiple participants can concurrently view, edit and talk about common data depending on privilege levels of each of the participants.

There are mainly two kinds of screen sharing systems in prior art. One that provides complete access to all screen content to all participants and another that provides selective access to some parts of screen content.

Prior art methods that provide access to all parts of the screen content are mostly used among participants who can be trusted. Such methods that are applicable to participants who are trusted are not the subject of this invention.

A screen sharing method that is applicable to participants who may or may not be trusted is the subject of this invention. This is enabled by providing selective access to both application data and application logic of an application.

Prior art methods that provide selective access to some parts of screen content provide selective access to only the data part of a shared application. There are no known prior art methods that provide selective access to both application data and application logic without the need for significantly redesigning the application.

One of the key features needed in a screen sharing system that is to be used among participants who may not be fully trusted is to provide selective access to both application data and application logic.

Selective access to application data enables users of a shared application to view data from any part of the application.

Selective access to application logic enables users of a shared application to operate on any functionality of a shared application without the need to change the application itself.

This is important as participants of a shared application session may want to expose only certain parts of an application to other participants. This occurs when a user wants services of a service provider who cannot be trusted with all parts of application logic and data.

There are several products in prior art that use screen sharing methods such as webex, vnc and citrix.

Most screen sharing methods in prior art assume that a screen is shared among trusted participants. This implies that if a document is being viewed with an application that is using a screen sharing method, all parts of the graphical user interface of this application are available to all participants engaged in a screen sharing session as everyone in a screen sharing session is a trusted participant.

But it is not always true that all participants in a screen sharing session are trusted participants.

To address this problem, some prior art screen sharing methods enable sharing of selective parts of a screen by hiding some parts and disabling user input from related parts that are not to be shared.

Such methods of hiding parts of a screen or disabling user input such as keyboard and pointer access to certain parts of applications are impractical and not scalable. For example, specifying hidden areas of a document that contain several hundred pages will become impractical. Similarly disabling different parts of an application without knowing dependencies between parts is not scalable. Software applications such as desktop publishing software including spreadsheets, word processors and presentation editors have several million lines of code, and tracking all of this functionality and disabling only some of it is not feasible.

As an example, disabling keyboard or pointer events to certain areas of an application screen is impractical since each event may initiate several related event handlers, and identifying related handlers is not possible without having the source code for the application. Hence disabling an area from receiving events may disable related event handlers that are necessary for maintaining a meaningful state of an application being shared.

In particular, if pointer events are tracked by a word processor application and corresponding pointer co-ordinates are updated into a vertical and horizontal scale graphical user interface component, the co-ordinate updates will get out of sync with the actual position of the pointer if pointer events in specified regions are disabled.

Hence it can be seen that disabling parts of user interface or hiding parts of a screen is not a scalable method to achieve selective access to data and application logic of a shared application.

There are other screen sharing methods that propose sharing a workspace with private and public shared views. But such systems will have to maintain a lot of contextual data for each of the views to keep track of what parts of a document or an application are private and what parts are public. Even if application data is partitioned, application logic cannot be partitioned by this means since such methods only offer access to data and not the logic of a shared application. Hence, such systems cannot be used with existing user interfaces of applications without significant changes to design and architecture of the application being shared.

There are no known screen sharing methods in prior art that offer selective access to both application data and application logic of an application that is shared among participants.

Hence it can be seen that there is a need for a screen sharing system that enables selective access to both application data and application logic that does not suffer from the disadvantages mentioned above with prior art methods.

Following paragraphs in current section describe relevant prior art in this field.

Prior art U.S. Pat. No. 5,107,443 proposes a method to share workspace using private regions. This method also mentions about preventing processing of user interface events from certain regions of a shared workspace. This prior art suffers from above mentioned disadvantages where specifying private regions can become too complex with large documents and preventing user interface event processing in select regions of a shared workspace may lead to application state problems.

Prior art U.S. Pat. No. 6,564,246 proposes a method to provide shared and independent views of a shared workspace. This method proposes sharing of common data in a workspace. This method expects the use of a new client server architecture where a server program has an ability to provide private and shared regions in a workspace, such that shared regions share a common data set across many clients and private regions are kept private. But there is no mention of how application logic is partitioned among the participants using this system. There is mention of rectangular regions to depict shared or private regions, but such rectangular regions cannot be used to partition application logic which is dependant on triggering of related event handlers and may not be accessible in rectangular regions. Hence this method can be used for selective access to application data but not application logic. This is further clarified by focusing on the design of proposed client applications in this method, where each client application is implemented as a separate application that manages common or private data using its own data management logic and not using the logic of shared application.

Also, keeping track of private and shared regions of a workspace is only possible if an application in this workspace is designed to support such a feature. But conventional graphical applications are designed for single user use, and they do not support such features. Hence this method cannot be used with existing applications unless they are designed differently.

As can be seen from above, all known prior art methods, suffer from some limitations in providing a screen sharing system, that enables selective access to both application logic and application data of a shared application.

### BACKGROUND OF THE INVENTION—OBJECTS AND ADVANTAGES

Accordingly, several objects and advantages of the present invention are:
a) to provide a screen sharing system that enables selective access to application data of a shared application;
b) to provide a screen sharing system that enables selective access to application logic of a shared application;
c) to provide a screen sharing system that provides selective access to both application data and logic without the need for change in existing application design; and
d) to provide a screen sharing system that enables applications to be shared with participants who are fully trusted and participants who may not be fully trusted.

### SUMMARY

In accordance with present invention a screen sharing method that enables selective access to application data and application logic is described.

This is achieved by combining an application to be shared, further referred to as content application, with a helper application using graphical user interface application programming interface provided by a window system.

The helper application is enabled with the ability to access contents of a shared application and initiate event handlers of the shared application using graphical user interface application programming interface provided by the window system. Ability to provide programmatic access to event handlers of content application is unique to this invention and is not available in any known prior art. Most prior arts only propose direct user interaction with rectangular sub regions of a shared application screen which will lead to problems of inconsistent application state as mentioned in the background section.

Graphical user interface application programming interface enables the helper application to access contents of any screen content of the content application. This enables access to any data of the content application from any screen without limiting access to specific rectangular regions. Use of graphical user interface application programming interface also enables access to application logic of a content application using user interface events that simulate user actions. Programmatic triggering of event handlers enables simulation of a real user input, hence guaranteeing that correct event handlers corresponding to a consistent application state are executed. There is no need to prevent events from certain regions of the shared application screen as only those events that are needed for selective data or selective application access will be triggered by the helper application.

Also, since window system application programming interface works across any application, there is no need to implement a custom interface for each content application and there is no need to redesign an existing content application to offer selective access to both application data and application logic. Hence this method will work across all existing applications.

Regarding what is shown in the display of a trusted participant and not fully trusted participant, the output screen of the helper application is displayed across all participants and the main content application screen may be displayed only to the owner of the content application and not to all participants. This enables selective access to application data and application logic across trusted and not trusted participants.

The preferred embodiment of the helper application is a spreadsheet application. Spreadsheet application is the preferred embodiment as it offers data cells to store data from a content application and a programming environment such as visual basic that can be used to initiate event handlers in the content application. But other helper applications that have the capability to render data from content application and initiate event handlers on the content application can also be used.

Data may be first entered into the helper application by a participant and this may be automatically copied into content application using window system graphical user interface application programming interface. Some data may be copied only after verification by the owner of content application. Similarly, data may be captured into helper application from the content application automatically using the graphical user interface application programming interface or could be copied manually if need be.

This method of first interacting with helper application which then programmatically simulates user input into the content application is unique to this invention and offers the benefit of selective access to desired application data and application logic without the need to mark public and private rectangular regions and without the need to compromise on application state while preventing access to certain parts of a shared application.

### DRAWINGS—FIGURES

FIG. 1 shows system architecture for a screen sharing system with selective access to data and application logic as a server based implementation.

FIG. 2 shows system architecture for a screen sharing system with selective access to data and application logic as a peer to peer implementation.

FIG. 3 shows an authoring system for setting up the helper application.

FIG. 4 shows a flow chart of a screen sharing session.

FIG. 5 shows a flow chart of authoring session.

FIG. 6 shows a use case of present invention for medical transcription application using a mobile device showing content application screen only.

FIG. 7 shows a use case of present invention for medical transcription application using a mobile device showing helper application screen only.

FIG. 8 shows a use case of present invention for medical transcription application using a mobile device showing helper application screen overlaid on content screen.

FIG. 9 shows a use case of present invention for medical transcription application using a mobile device showing content screen on top of helper application screen.

FIG. 10 shows a use case for Customer Relationship Management (CRM) application.

FIG. 11 shows a use case for legal transcription application.

FIG. 12 shows a use case for automobile insurance transcription application.

FIG. 13 shows a use case for utility service application.

FIG. 14 shows a use case for business transcription application.

FIG. 15 shows a use case for weight tracker application.

FIG. 16 shows a use case for calendar application.

FIG. 17 shows a use case for blogging application.

FIG. 18 shows a use case for email application.

### DRAWINGS—REFERENCE NUMERALS

31 Mobile device

32 screen sharing server

33 internet

34 helper desktop computer

35 content application

36 helper application

37 Forward data and logic mapping

38 reverse data and logic mapping

39 screen sharing server hosting session management

40 Authoring application

41 authoring server

42 Functional block

43 functional block

44 functional block

45 functional block

46 functional block

47 functional block

48 functional block

49 functional block

50 functional block

51 functional block

52 functional block

53 functional block

54 functional block

55 functional block

56 functional block

57 functional block

58 functional block

59 medical content application

60 patient name

61 social security number

62 date of birth

63 diagnosis text box

64 CRM content application

65 user name

66 price

67 description header

68 description text box

69 Legal transcription content application

70 case number

71 name of the judge

72 case history header

73 case history description

74 Automobile insurance transcription content application

75 case number

76 social security number

77 case history header

78 case history description

79 Utility service content application

80 order number

81 job cost estimate

82 job description header

83 job description

84 Business transcription content application

85 session number

86 session status

87 session description header

88 session description

89 Weight tracker content application

90 patient name

91 social security

92 weight tracker header

93 weight tracking table

94 Calendar management content application

95 owner name

96 private appointment field

97 public appointment field

98 calendar

99 Blogging content application

100 blog number

101 supervisor comments text box

102 details header

103 blog details text box

104 email application

105 get font code fragment

106 menu subsystem

107 font settings dialog

108 set font code fragment

### DETAILED DESCRIPTION OF PREFERRED EMBODIMENT

Screen sharing system that enables selective access to data and application logic can be between any two users using either desktop computers or mobile devices or any combination of such computing devices. In the following descriptions, two system architectures are described that may be used to implement a screen sharing system that provides selective access to data and logic of a content application between participants in a screen sharing session using a helper application.

First system architecture describes a server based implementation where all application service logic code and user interface code for content application and helper application is hosted at a server.

Second system architecture describes a screen sharing session using a peer to peer network where all application service logic code and user interface code of content application and helper application is hosted at a client device and screen output of helper application is displayed at a desktop computer of a helper using peer to peer networking.

Then several use cases are described where a content application owner carrying a mobile device interacts with a helper who is at a desktop computer providing remote editing services in real time to the mobile device user using the screen sharing system of present invention.

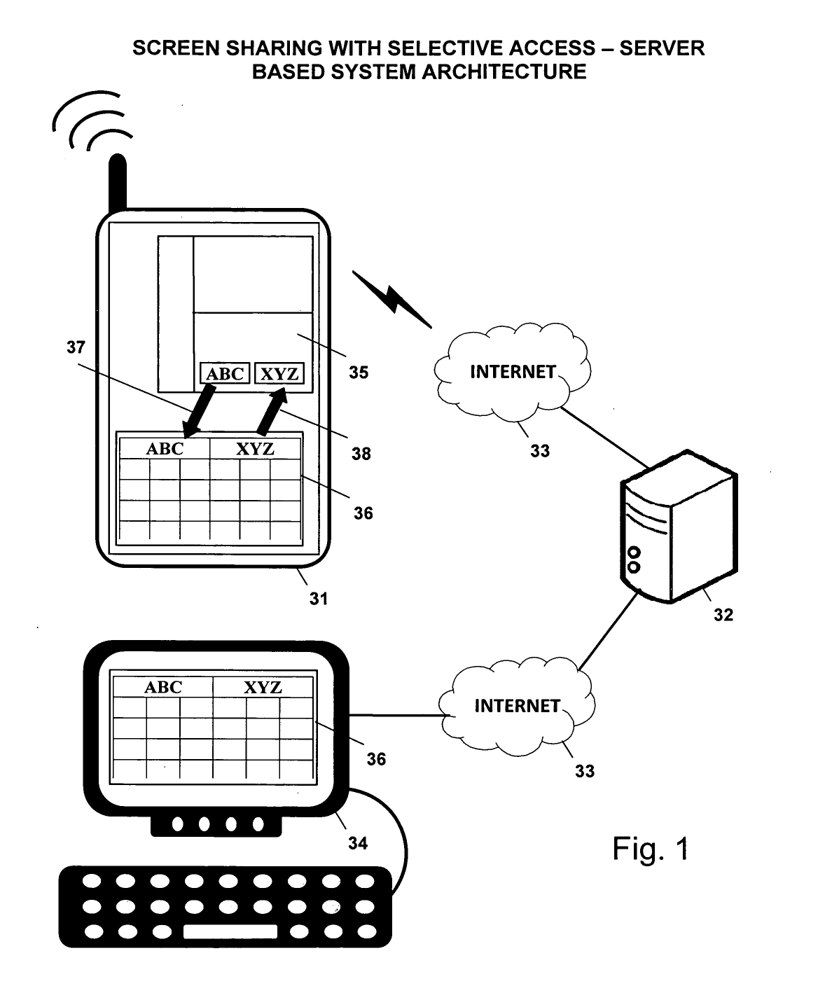

FIG. 1 shows system architecture of screen sharing system of present invention using a server based implementation that provides selective access to application logic and application data. This shows a screen sharing session between a mobile device user and a helper at a desktop computer, who provides remote editing services in real time. Mobile device 31 in preferred embodiment is a smart phone device that wirelessly connects to screen sharing server 32 using internet 33. Mobile user using mobile device 31, engages in screen sharing session with helper using helper desktop computer 34. Mobile device 31 has a smaller display screen resolution of 640 pixel by 480 pixel resolution as compared with the display resolution of a helper desktop computer 34.

In this server based implementation, screen sharing server 32 hosts application service logic code and user interface code, of content application 35 and helper application 36, and screen output of user interface code is displayed at mobile device 31 and desktop computer 34.

First mobile device user initiates the launching of content application 35 at mobile device 31. This initiation to launch content application is transferred to screen sharing server 32, which then executes content application service logic code and user interface code. The screen output of user interface code of content application is then transferred to mobile device 31.

Then mobile device user initiates the launch of helper application 36 at mobile device 31. This initiation to launch helper application is also transferred to screen sharing server 32, which then executes helper application service logic code and user interface code. The screen output of user interface code of helper application is then transferred to helper desktop computer 34 and optionally to mobile device 31.

Helper application 36 is coupled to content application 35 such that helper application 36 gets selective access to data and logic of content application 35.

The coupling between content application 34 and helper application 36 is setup using forward and reverse data and logic mapping between content application 34 and helper application 36.

Forward data and logic mapping 37 determines data and logic that are shared from content application 35 to helper application 36 and reverse data and logic mapping 38 determines the data and logic that content application 35 can accept from helper application 36.

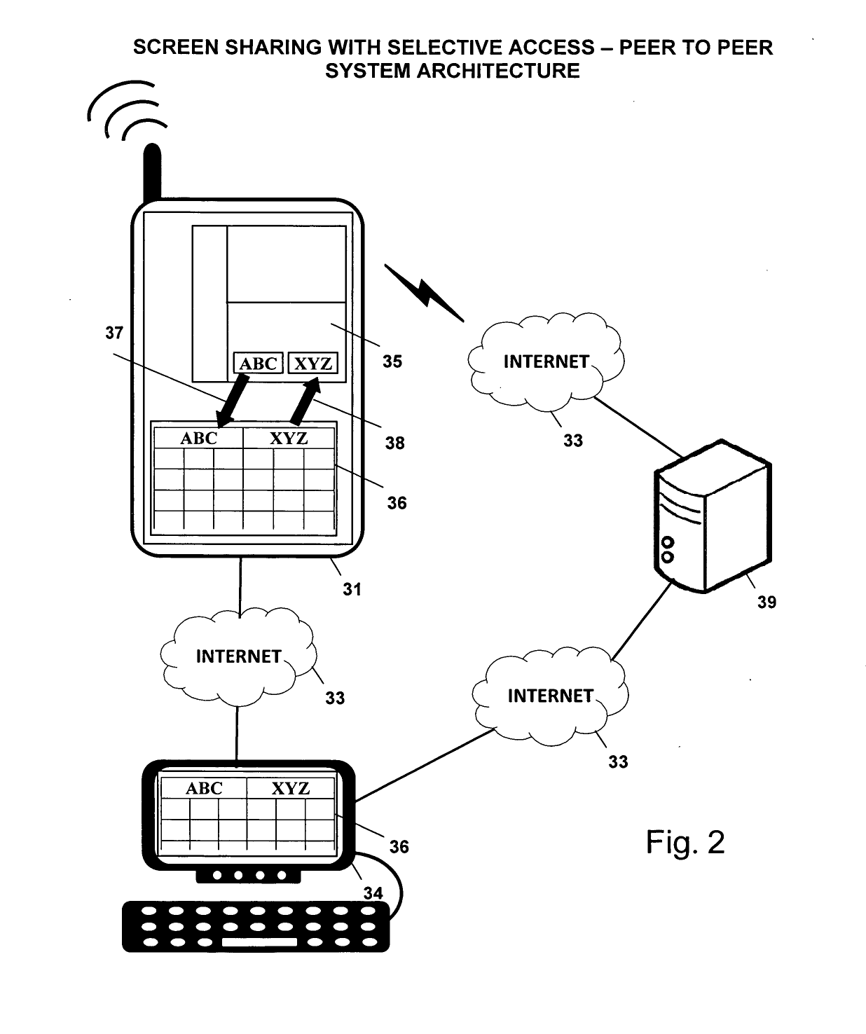

FIG. 2 shows system architecture using peer to peer implementation between mobile device 31 and helper desktop 34. In this implementation, screen sharing server hosting session management 39 does not host content application 35. Instead, it performs only session management between mobile device 31 and helper desktop 34 during screen sharing session. Mobile device executes content application 35 and helper application 36 whereas desktop displays screen output of helper application 36.

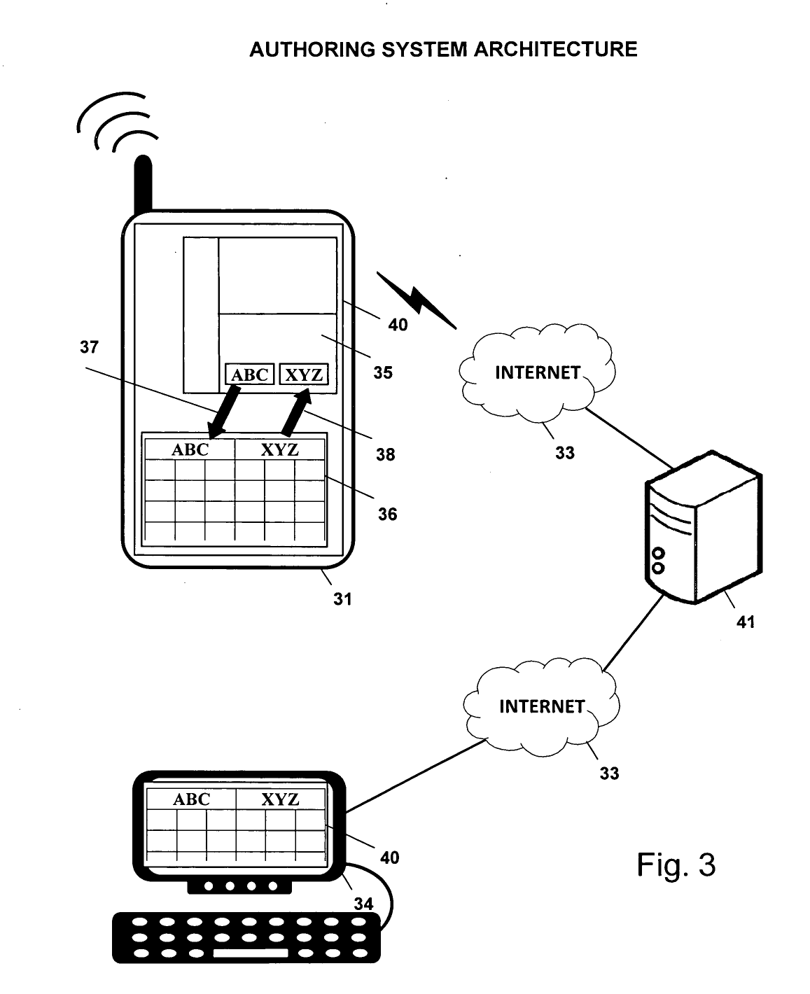

FIG. 3 shows authoring system architecture proposed by this invention. Authoring application 40 allows users to invoke content application 35 and helper application 36 and by using point and click interface, establish forward data and logic mapping 37 and reverse data and logic mapping 38. For frequently used content application 35, it is beneficial to store sharing details between content application 35 and helper application 36 in authoring server 41 persistently. This enables mobile user using mobile device 31 to easily seek for help when needed. During authoring session, authoring application 40 is launched in desktop device 34.

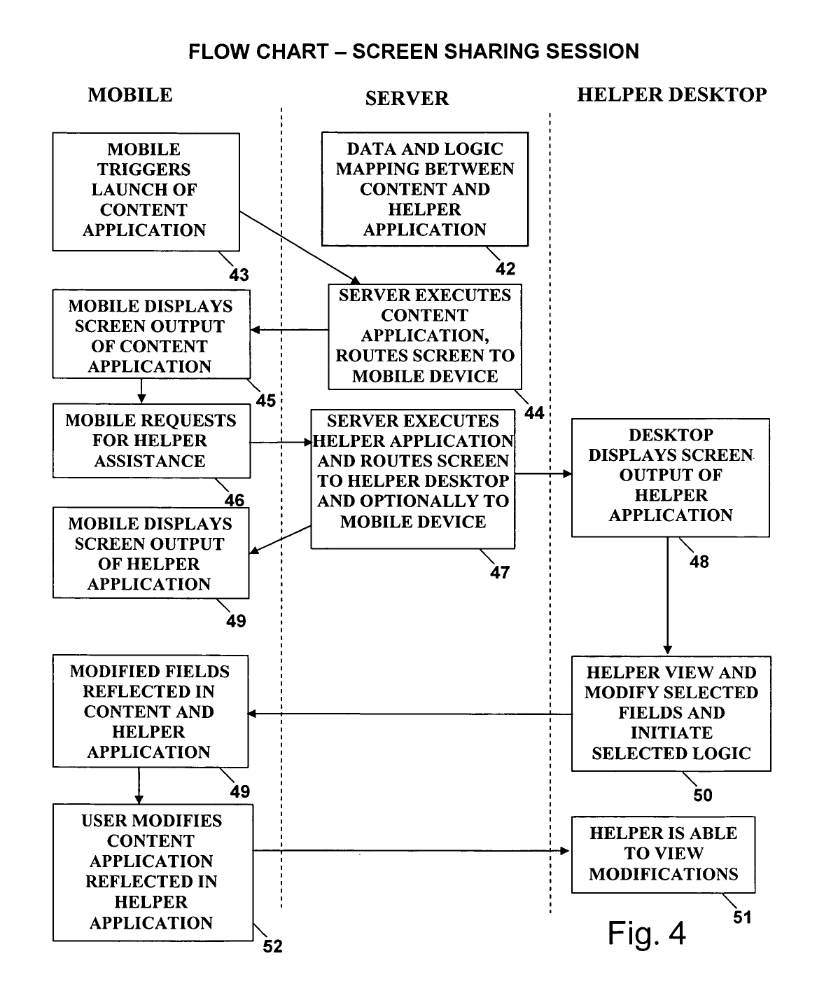

FIG. 4 shows the flow chart of screen sharing session using server based implementation of present invention. Functional block 42 assumes that data and logic mapping between content application 35 and helper application 36 already exists and persistently stored in the server 32 as shown in FIG. 1.

In functional block 43, mobile device 31 initiates the launch of content application 35 which is then routed to server 32.

Then in functional block 44 server 32 executes content application 35 and routes the screen output of content application 35 to mobile device 31.

Then in functional block 45 mobile device displays screen output of content application 35.

Then in functional block 46 mobile user requests for remote editing assistance and the request is transferred to server 32.

After receiving this request, server 32 in functional block 47 executes helper application 36 and the screen output of helper application is routed to helper desktop computer 34 in functional block 48 and optionally to mobile device 31.

In response to screen routing messages from output of helper application mobile device 31 displays screen output of helper application 36 in functional block 49.

In functional block 50, screen output of helper application is displayed in desktop computer 34.

Now in functional block 51, helper views selected data and can access selected logic of content application using data and logic mapping that is already created and stored at server in functional block 42. Any interaction with content application is only through helper application and corresponding mapping.

Helper modifies selected data and also initiates selected logic of content application and these changes are transferred to server 32 which then reflects these changes into the screen output of content application at the mobile device 31.

In functional block 49, all the data that is modified by helper is shown in mobile device 31, and result of any logic that is executed in helper application 36 corresponding to content application is also reflected at the mobile device 31.

In functional block 52, mobile device user modifies certain portions of content application, and data corresponding to this change is routed through server 32 to helper desktop in functional block 51.

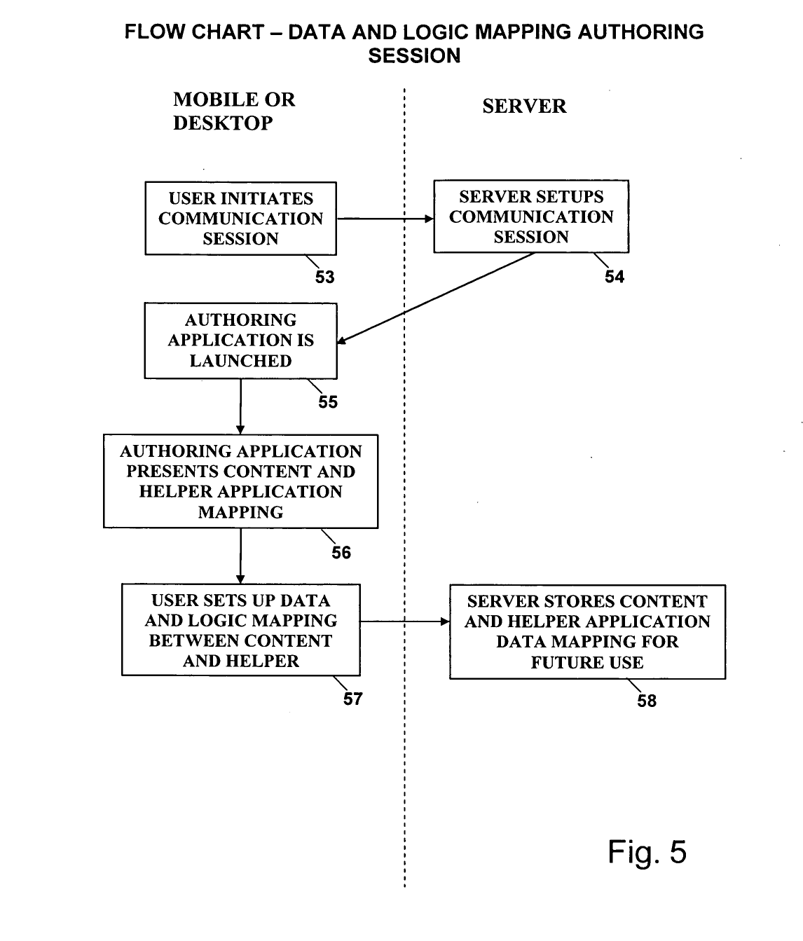

FIG. 5 shows the flow chart of authoring session in which a user can setup mapping of data and logic sharing between content application 35 and helper application 36 in authoring server 41. In functional block 53 user initiates communication session with server by using mobile device 31 or a desktop device 34. Then authoring server 41 sets up communication session in functional block 54 with mobile device 31. In functional block 55, authoring application is launched in mobile device 31 and in functional block 56 authoring application presents content and helper application mapping interface. In functional block 57, user sets up forward and reverse data and logic mapping between content and helper application using point and click interface. In functional block 58, server stores the data mapping in persistent storage for further use.

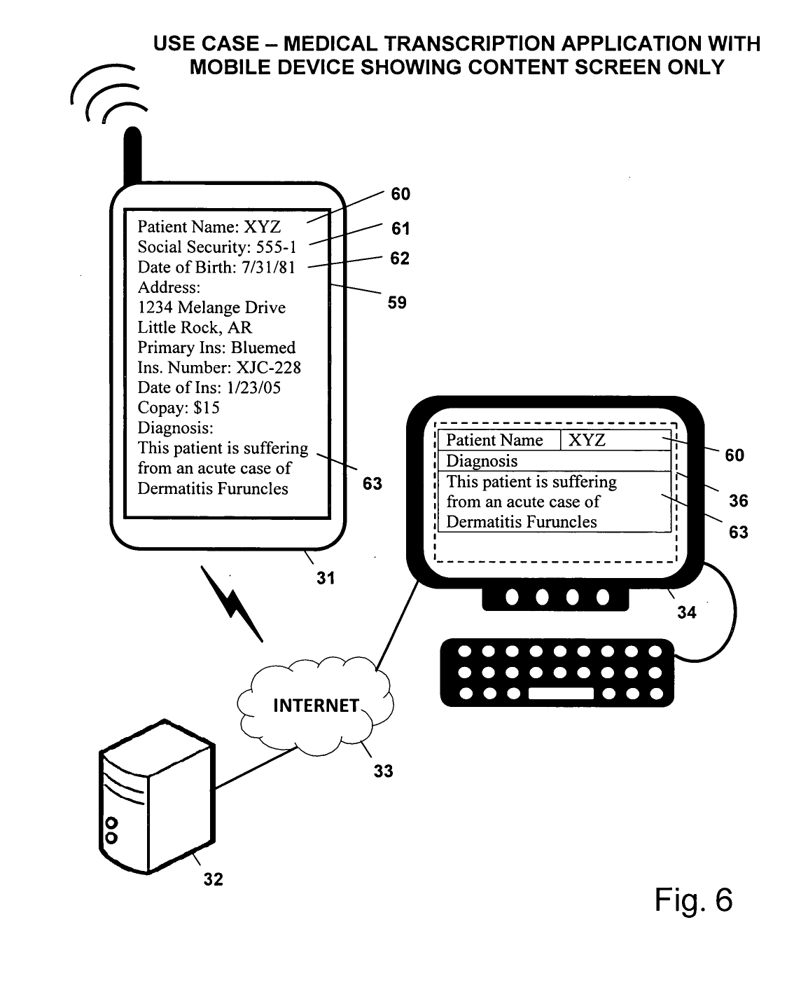

FIG. 6 shows a use case of present invention where content application is a medical transcription application. Mobile user, who may be a medical professional, uses mobile device 31 to fill patient information in medical transcription screen. Due to screen and keyboard size limitation of mobile device 31, medical professional requires help filling fields of medical content application 59. The fields of medical content application 59 that are displayed on mobile device 31 can be configured by medical professional at the time of creating data and logic mapping between medical content application 59 and helper application 36. The configuration chosen by the medical professional is based on the scenario in which the medical professional chooses to use the application.

In current scenario, medical professional may want to see the full medical details of the patient. In this scenario, the medical content application 59 is displayed on mobile device 31. The helper application 36 on mobile device 31 remains hidden. The data modified by helper desktop 34 is displayed in fields of medical content application 59 on mobile device 31.

Medical content application 59 shows a sample medical transcription screen with patient name 60, social security number 61, date of birth 62 and other patient record details including a diagnosis text box 63. Because of confidentiality regulations, medical professional may want to show patient name 60 but hide social security number 61 in helper desktop 34. These restrictions are placed when data and logic mapping are done between medical content application 59 and helper application 36. Accordingly, in helper desktop 34, helper application 36 shows patient name 60 with additional graphical attributes to indicate non editable text. Diagnosis text box 63 can be edited and changes are reflected in both helper application 36 as well as content application 59 of mobile device 31.

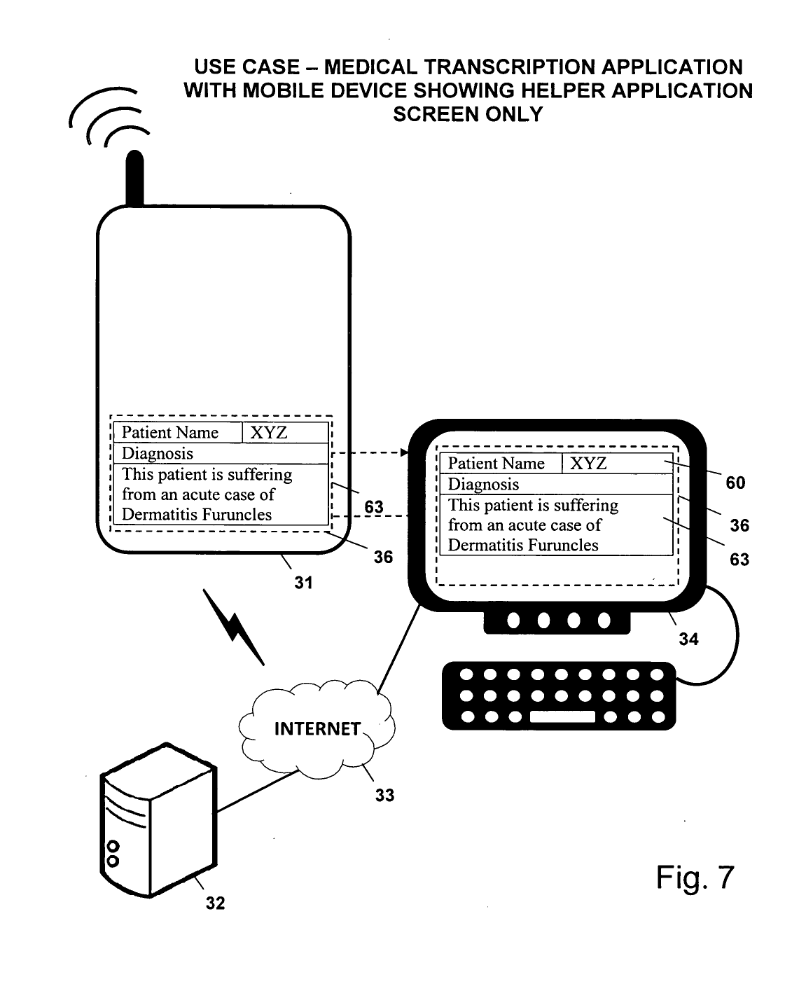

FIG. 7 shows a use case of medical transcription application where the medical professional is already familiar with all the fields of the medical content application 59 and hence wants to see only the fields being edited by helper application 36. In this configuration, the medical content application 59 is hidden from view and only the helper application 36 is displayed on mobile device 31.

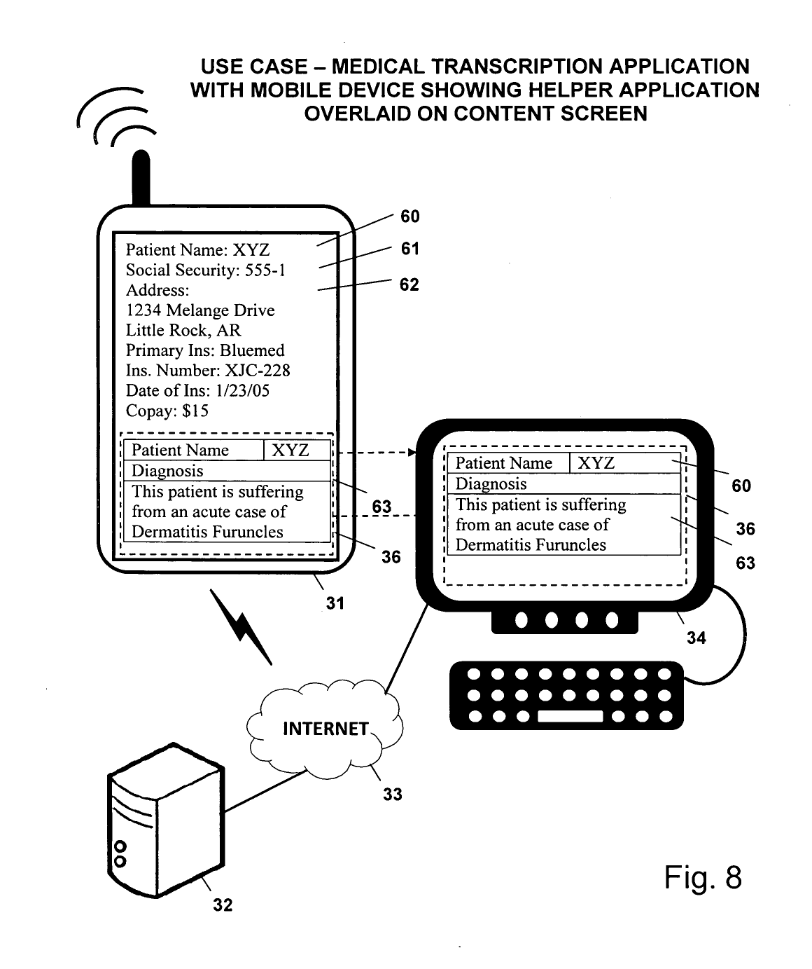

FIG. 8 shows another configuration of medical transcription application in which medical professional may want to see medical content application 59 along with helper application 36. In case of mobile devices 31 with small screens, the helper application 36 is overlaid on top of the medical content application 59. The screen of helper application 36 is translucent so that all data updates made to helper application 36 are seen in both content application screen and helper application screen at mobile device 31.

For mobile devices 31 with large screens, medical content application 59 and helper application 36 can be configured to reside side by side or top and bottom layout. This configuration enables medical professional to verify the validity of the data that is coming into the helper application 36 and if the same data is transferred correctly to medical content application 59.

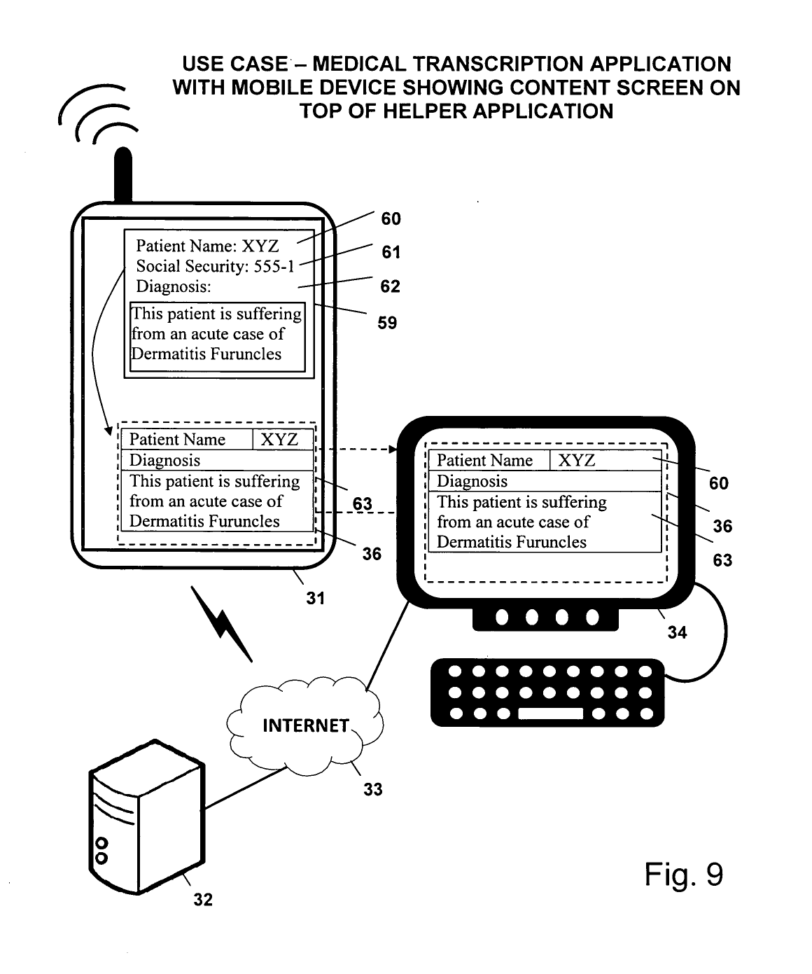

FIG. 9 illustrates the top and bottom layout where medical content application 59 is displayed on top portion of the screen and helper application 36 is displayed just below at the mobile device 31. Any data changes made to the fields in helper application 36 are reflected in medical content application 59.

For the remainder of this description, it is assumed that mobile device 31 has a large screen and that user of mobile device 31 chooses a configuration in which content application 59 resides on top portion of the screen and helper application 36 resides below it in mobile device 31. This invention enables selective data and logic sharing of applications without involving costly reimplementation of existing applications.

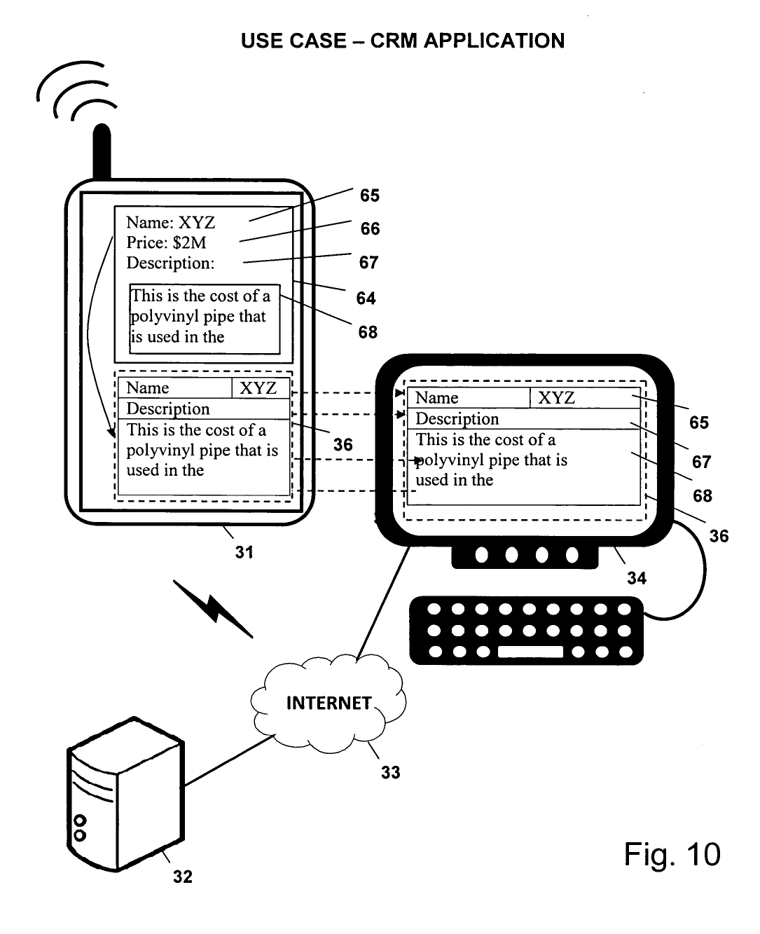

FIG. 10 shows a use case of present invention where content application is a Customer Relationship Management (CRM) application. CRM content application 64 shows a sample CRM screen involving user name 65, price 66, description header 67 and description text box 68. Mobile user using mobile device 31 uses this screen to update CRM user record. Due to screen and keyboard size limitation of mobile device 31, user requires help while filling description text box field 68. But due to security considerations, user wants to hide price field 66 from helper desktop 34 and also wants to disable helper from modifying user name field 65. These above restrictions are placed while data and logic mapping are done between CRM content application 64 and helper application 36. Accordingly, in helper desktop 34, helper application 36 shows name field 65 but helper cannot edit that field, whereas description text box 68 can be edited and the changes are reflected in both helper application 36 as well as content application 64 of mobile device 31.

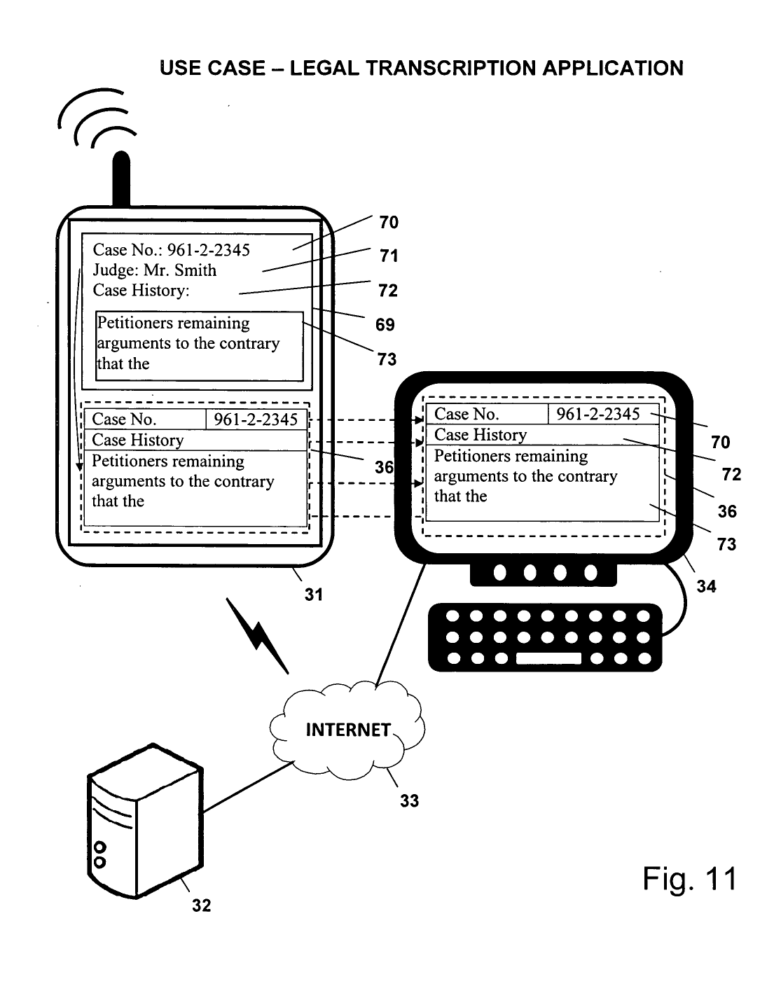

FIG. 11 shows a use case of present invention where content application is a legal transcription application. Legal transcription content application 69 shows a sample screen with case number 70, name of the judge 71, case history header 72 and text box for case history description 73. Mobile user using mobile device 31 uses this screen to update case history details. Due to screen and keyboard size limitation of mobile device 31, user requires help for entering text in text box for case history description 73. But due to security considerations, user wants to hide name of the judge 71 from helper desktop 34 and also wants to disable helper from modifying case number 70. These above restrictions are placed while data and logic mapping are done between 69 and 36. Accordingly, in helper desktop 34, helper application 36 shows case number 70 but helper cannot edit that field, whereas case history description 73 can be edited and the changes are reflected in both helper application 36 as well as content application 69 of mobile device 31.

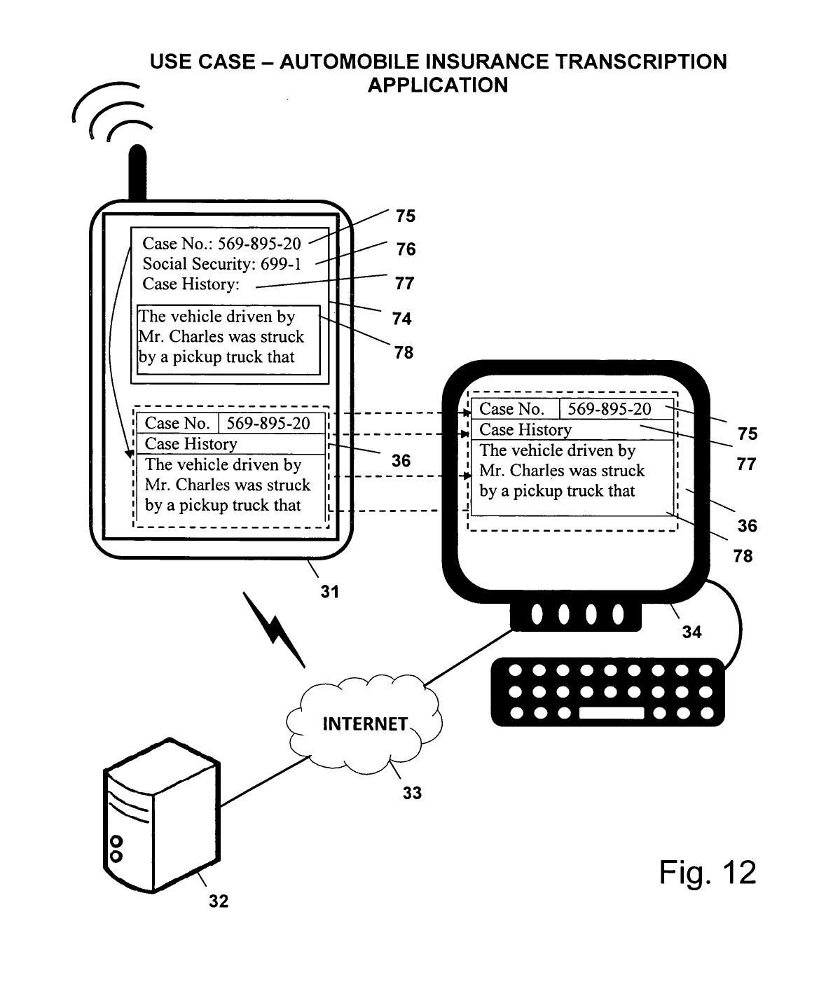

FIG. 12 shows a use case of present invention where content application is an automobile insurance transcription application. Automobile insurance transcription content application 74 shows a sample screen with case number 75, social security number 76, case history header 77 and text box for case history description 78. Mobile user using mobile device 31 uses this screen to update case history details. Due to screen and keyboard size limitation of mobile device 31, user requires help for entering text in text box for case history description 78. But due to security considerations, user wants to hide social security of insured 76 from helper desktop 34 and also wants to disable helper from modifying case number 75. These above restrictions are placed while data and logic mapping are done between 74 and 36. Accordingly, in helper desktop 34, helper application 36 shows case number 75 but helper cannot edit that field, whereas case history description 78 can be edited and the changes are reflected in both helper application 36 as well as content application 74 of mobile device 31.

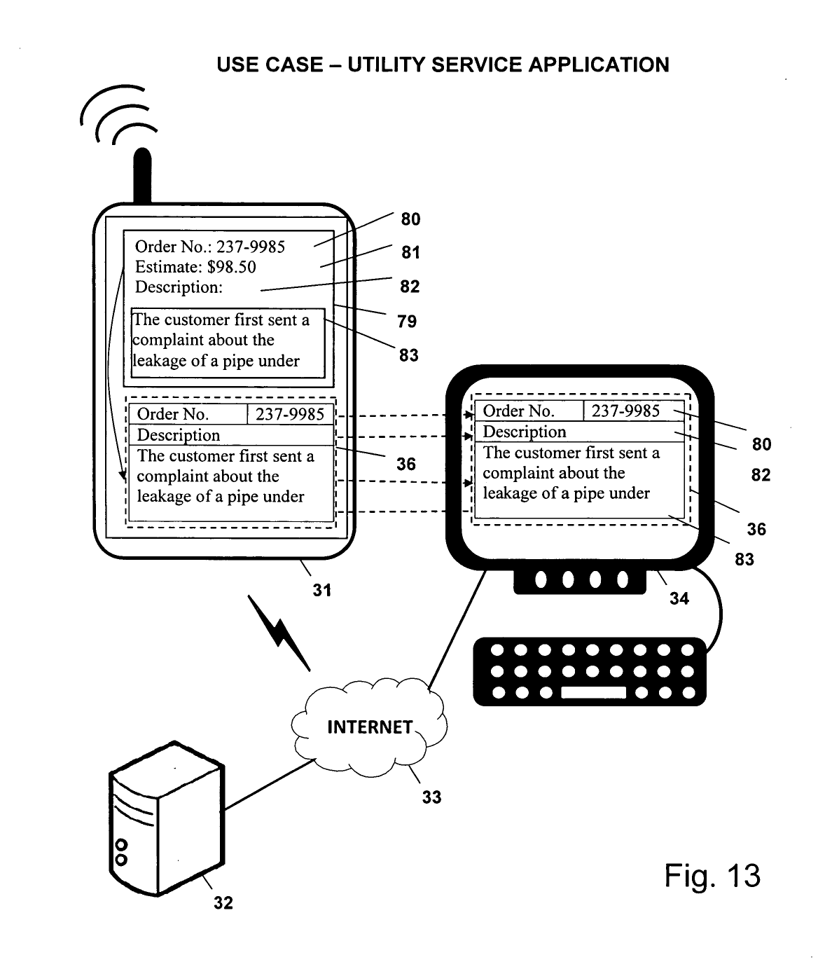

FIG. 13 shows a use case of present invention where content application is a utility service application. Utility service content application 79 shows a sample screen with order number 80, job cost estimate 81, job description header 82 and text box for job description 83. Mobile user using mobile device 31 uses this screen to update job description details. Due to screen and keyboard size limitation of mobile device 31, user requires help for entering text in text box for job description 83. But due to security considerations, user wants to hide job cost estimate 81 from helper desktop 34 and also wants to disable helper from modifying order number 80. These above restrictions are placed while data and logic mapping are done between 79 and 36. Accordingly, in helper desktop 34, helper application 36 shows order number 80 but helper cannot edit that field, whereas job description 83 can be edited and the changes are reflected in both helper application 36 as well as content application 79 of mobile device 31.

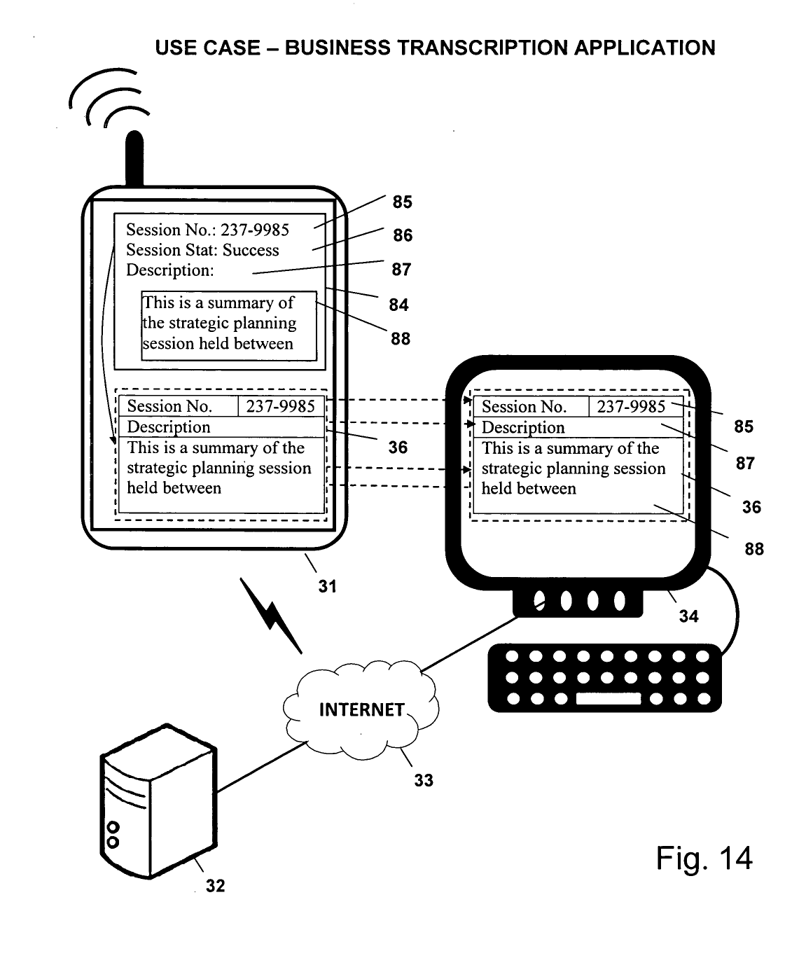

FIG. 14 shows a use case of present invention where content application is a business transcription application. Business transcription content application 84 shows a sample screen with session number 85, session status 86, session description header 87 and text box for session description 88. Mobile user using mobile device 31 uses this screen to update session description details. Due to screen and keyboard size limitation of mobile device 31, user requires help for entering text in text box for session description 88. But due to security considerations, user wants to hide session status 86 from helper desktop 34 and also wants to disable helper from modifying session number 85. These above restrictions are placed while data and logic mapping are done between 84 and 36. Accordingly, in helper desktop 34, helper application 36 shows session number 85 but helper cannot edit that field, whereas session description 88 can be edited and the changes are reflected in both helper application 36 as well as content application 84 of mobile device 31.

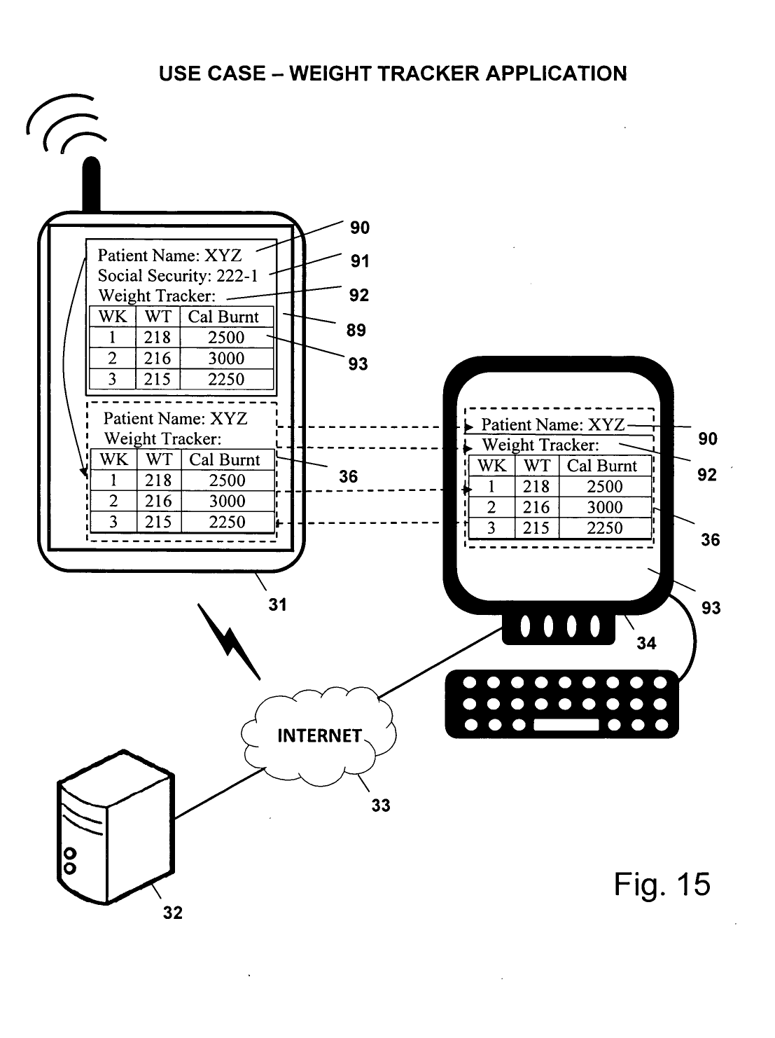

FIG. 15 shows a use case of present invention where content application is a weight tracker application. Weight tracker content application 89 shows a sample screen with patient name 90, social security 91, weight tracker header 92 and weight tracking table 93. Mobile user using mobile device 31 uses this screen to update weight tracking details. Due to screen and keyboard size limitation of mobile device 31, user requires help for entering data in weight tracking table 93. But due to security considerations, user wants to hide social security number 91 from helper desktop 34 and also wants to disable helper from modifying patient name 90. These above restrictions are placed while data and logic mapping are done between 89 and 36. Accordingly, in helper desktop 34, helper application 36 shows patient name 90 but helper cannot edit that field, whereas weight tracking table 93 can be edited and the changes are reflected in both helper application 36 as well as content application 89 of mobile device 31.

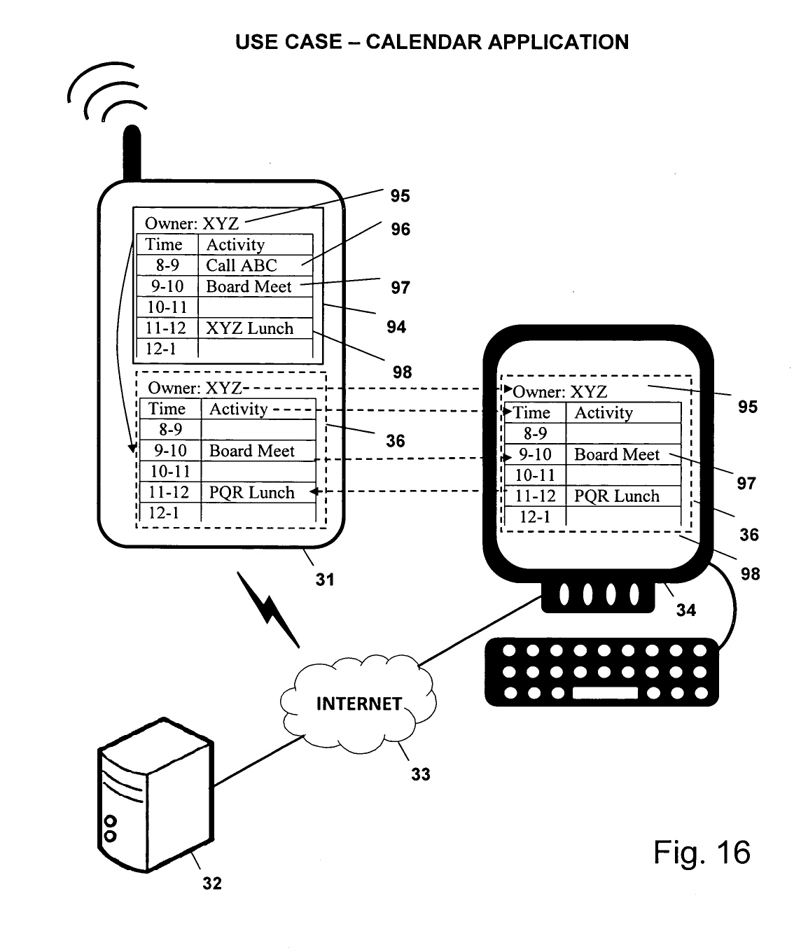

FIG. 16 shows a use case of present invention where content application is a calendar management application. Calendar management content application 94 shows a sample screen with owner name 95, private appointment field 96, public appointment field 97 and calendar 98. Mobile user using mobile device 31 uses this screen to update calendar appointments. Due to screen and keyboard size limitation of mobile device 31, user requires help for entering appointments into calendar 98. But due to security considerations, user wants to hide private appointment field 96 from helper desktop 34 and also wants to disable helper from modifying owner name 95. These above restrictions are placed while data and logic mapping are done between 94 and 36. Accordingly, in helper desktop 34, helper application 36 shows owner name 95 but helper cannot edit that field, whereas entries in calendar 98 can be edited and the changes are reflected in both helper application 36 as well as content application 94 of mobile device 31.

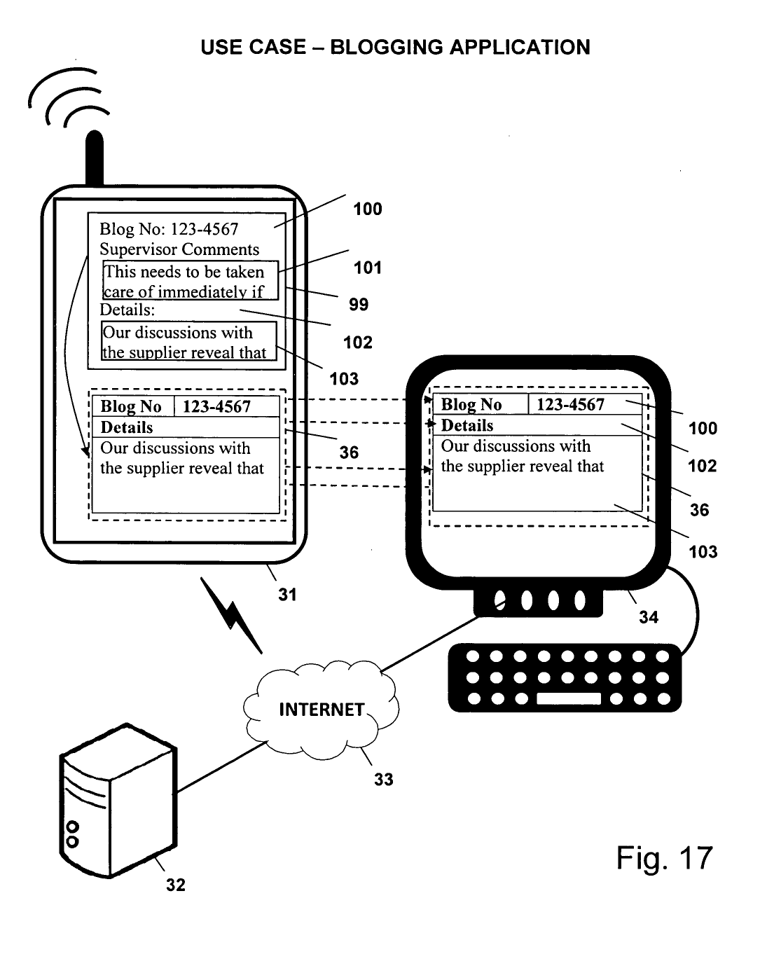

FIG. 17 shows a use case of present invention where content application is a blogging application. Blogging content application 99 shows a sample screen with blog number 100, supervisor comments text box 101, details header 102 and blog details text box 103. Mobile user using mobile device 31 uses this screen to fill in and update blog information. Due to screen and keyboard size limitation of mobile device 31, user requires help for entering appointments into blog details text box 103. But due to security considerations, user wants to hide supervisor comments text box 101 from helper desktop 34 and also wants to disable helper from modifying blog number 100. These above restrictions are placed while data and logic mapping are done between 99 and 36. Accordingly, in helper desktop 34, helper application 36 shows blog number 100 but helper cannot edit that field, whereas entries in blog details text box 103 can be edited and the changes are reflected in both helper application 36 as well as content application 99 of mobile device 31.

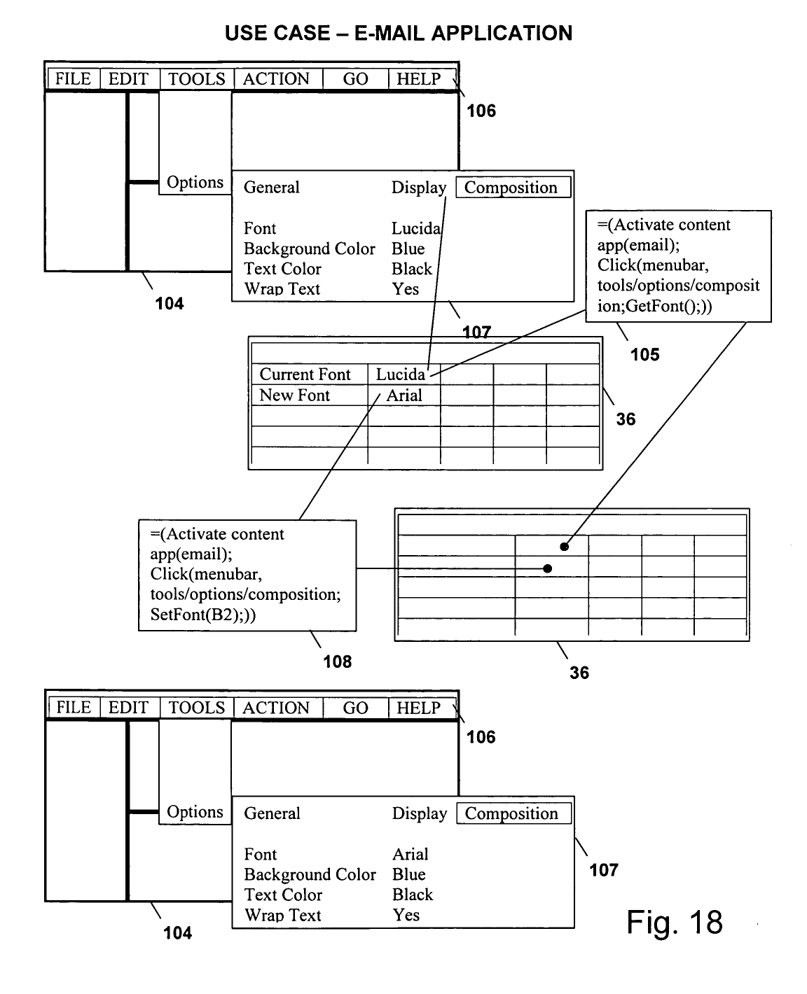

FIG. 18 shows a use case of present invention where content application is a email application 104. This use case shows how selective access to logic of content application is provided. Email application 104 provides email authoring functionality. A mobile device user, who is unable to author a complete email due to the size of display and keypad at mobile device 31, gets help from a helper at desktop 34. But the helper at desktop 34 wants to change the font settings of email application 104 before providing editing services. Hence the user of email application enables selective access to font settings by providing a code fragment that helper can execute in helper application. A get font code fragment 105 enables accessing the menu subsystem 106 of content application 35. This get font code fragment 105 when executed programmatically clicks menu subsystem 106 to get access to font settings dialog 107 and gets the value in font settings dialog into a field of helper application 36. Another field in helper application 36 is mapped with a new font value that is to be updated in font settings dialog 107. This new font value is updated into font settings dialog set font code fragment 108. When set code fragment 108 is executed at helper application, menu subsystem 106 is programmatically clicked and the new font value is set in font settings dialog 107. The programmatic clicks are done using window system programming interface.

This use case shows that any logic of content application that is accessible to a user can be accessed by helper application without limiting to particular regions of screen content as other prior art methods. The access to content application logic is restricted to only those functionalities that are allowed by the owner of content application.

Hence it can be seen that the screen sharing system of present invention that combines a helper application with programmatic access to content application, enables selective access to both application data and application logic of content application without having to redesign a content application.

Advantages

From the description above a number of advantages of the screen sharing method of present invention that combines a content application with a helper application become evident:
a) a screen sharing system is provided that enables selective access to application data of a shared application;
b) a screen sharing system is provided that enables selective access to application logic of a shared application;
c) a screen sharing system is provided that provides selective access to both application data and logic without the need for change in existing application design; and
d) a screen sharing system is provided that enables applications to be shared with participants who can be fully trusted and participants who cannot be fully trusted.

Conclusion, Ramifications and Scope

Accordingly, the reader will see that combining a content application with a helper application that is capable of programmatically accessing both data and logic of content application provides selective access to both application data and application logic without the need to redesign content applications and without giving rise to inconsistent application states as encountered with other prior art methods.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A screen sharing method that enables selective sharing of application data and application logic comprising:
a) displaying said application data from said application further referred to as content application, onto a display of a device associated with owner of said application;
b) coupling another application further referred to as helper application with said content application, using a programming interface, wherein said programmatic interface is a window system application programming interface;
c) getting data from said content application into said helper application using said programming interface;
d) setting data into said content application from said helper application using said programming interface;
e) invoking event handlers in said content application from said helper application using said programming interface;
f) responding to events in said content application with event handlers in said helper application;
g) optionally displaying screen output data of said helper application onto said display associated with said owner; and
h) displaying screen output of said helper application onto a display of another user further referred to as helper.

2. The method of screen sharing of claim 1, wherein said coupling between said content application and said helper application is based on client to client interaction using said window system application programming interface.

3. The method of screen sharing of claim 1, wherein said application data is selected from group consisting of graphical output data, image output data, video output data, and textual output data of said content application.

4. The method of screen sharing of claim 1, wherein said content application is selected from group consisting of productivity application, messaging application, communication application, web browser application, desktop application with graphical user interface, and server based application with graphical user interface.

5. The method of screen sharing of claim 1, wherein said helper application is selected from group consisting of spreadsheet application, and a programmable application, that interacts with said content application using said window system application programming interface.

6. The method of screen sharing of claim 1, further comprising:
a) initiating programmed code in said helper application to capture said application data from said content application;
b) displaying said captured data onto screen of said helper application displayed at said display associated with said owner and display of said helper.

7. The method of screen sharing of claim 1, further comprising:
a) associating display regions of said helper application output screen with display regions of said content application output screen such that change in data of said display region of said helper application is automatically transferred to said display region of said content application using said window system application programming interface, and change in data of said display region of said content application is automatically transferred to said display region of said helper application using said window system application programming interface.

8. The method of screen sharing of claim 1, further comprising:
a) associating display regions of said helper application output screen with display regions of said content application output screen such that change in data of said display region of said helper application is transferred to said display region of said content application using said window system application programming interface with control of said owner, and change in data of said display region of said content application is transferred to said display region of said helper application using said window system application programming interface with control of said owner.

9. The method of screen sharing of claim 7, wherein, said change in said content application is notified to said content application using window system events in said window system application programming interface.

10. The method of screen sharing of claim 9, wherein, said automatic transfer from said content application is initiated by said helper application in response to said notification event.

11. The method of screen sharing of claim 9, wherein, said association of said regions of said display regions of said helper application with said display regions of said content application is done by installing window system hooks of said window system application programming interface.

12. The method of screen sharing of claim 1, wherein geometric position of said display of said output data of said helper application in said display of said owner, is using geometric positioning methods selected from group consisting of overlapping opaque display method, overlapping translucent display method, and not overlapping display method.

13. The method of screen sharing of claim 1, wherein said window system is selected from group consisting of microsoft window system, macintosh window system, x window system, android window system, symbian window system, research in motion window system, java window system, and brew window system.
